(19) United States
(12) Patent Application Publication
(10) Pub. No.: US 2017/0098499 A1
(43) Pub. Date: Apr. 6, 2017

(54) MAGNETIC CORE PART, MAGNETIC ELEMENT, AND METHOD FOR PRODUCING MAGNETIC CORE PART

(71) Applicant: NTN CORPORATION, Osaka (JP)

(72) Inventors: Natsuhiko MORI, Aichi (JP); Hiroyuki NODA, Mie (JP); Eiichirou SHIMAZU, Mie (JP); Nobuyoshi YAMASHITA, Shizuoka (JP); Shougo KANBE, Mie (JP); Takayuki ODA, Mie (JP); Shinji MIYAZAKI, Mie (JP)

(21) Appl. No.: 15/129,320

(22) PCT Filed: Mar. 25, 2015
(86) PCT No.: PCT/JP2015/059145

§ 371 Date: Sep. 26, 2016

(30) Foreign Application Priority Data
Mar. 25, 2014 (JP) 2014-062230
Mar. 25, 2014 (JP) 2014-062781

(51) Int. Cl. H01F 27/255; H01F 41/02; H01F 27/28

(52) U.S. Cl. CPC H01F 27/255; H01F 27/2823; H01F 41/0246

(57) ABSTRACT

The present invention provides a magnetic core part by which failures such as cracks do not occur even if the magnetic core part contains 90% by mass or more of an amorphous metal powder. The magnetic core part is formed by thermoset molding at least one magnetic powder selected from an amorphous metal powder alone and an amorphous metal powder coated with an insulating material, and a thermosetting binder resin. The magnetic core part contains the magnetic powder in an amount of 90% by mass or more and 99% by mass or less with respect to the total amount of the magnetic powder and the thermosetting binder resin.

### TECHNICAL FIELD

The present invention relates to a magnetic core part and a magnetic element for electric devices and electronic devices such as inductors, transformers, antennas (bar antennas), choke coils, filters and sensors, and a method for producing the magnetic core part.

### BACKGROUND ART

In recent years, along with the progress of miniaturization of electric and electronic devices, increase of frequency and increase of current, magnetic core parts also have issues that should be dealt with similarly. However, in the current mainstream ferrite materials, the material properties themselves are approaching the limit, and thus a new magnetic core material is being searched. For example, ferrite materials are now being substituted by compressed magnetic materials such as Sendust and amorphous metals, or amorphous foil strips. However, the compressed magnetic materials have poor moldability, and also have low mechanical strength after being fired. Furthermore, the production costs of the amorphous foil strips are high due to winding, cutting and formation of gaps. Therefore, the practical application of these magnetic materials is delayed.

For the purpose of providing a method for producing small-sized and inexpensive magnetic core parts having various shapes and properties by using a magnetic powder having poor moldability, the applicant of the present invention obtained a patent for a method for producing a core part having predetermined magnetic properties by injection molding, including coating a magnetic powder contained in a resin composition for use in injection molding with an insulating material, and insert-molding either of a pressurized powder-molded magnetic substance and a pressurized powder magnet-molded article in the resin composition, wherein the pressurized powder-molded magnetic substance or the pressurized powder magnet-molded article contains a binder having a lower melting point than that of the injection molding temperature (Patent Document 1).

However, in the method described in Patent Document 1, when a magnetic powder such as an amorphous metal is applied to an injection-moldable thermoplastic resin such as polyphenylene sulfide (PPS), the limit of the amount of the magnetic powder that can be blended is about 88% by mass. If the magnetic powder is blended in a larger amount than this limit, there are problems that a mechanical strength sufficient for a core part cannot be obtained, such as generation of cracks. Furthermore, since the blending amount of the magnetic powder cannot be increased, there are problems that magnetic permeability cannot be improved, and that the core part cannot be miniaturized.

As a composite magnetic core including an amorphous magnetic thin strip as a magnetic core, there is known an electromagnetic device for a noise filter that can ensure insulation between a winding wire and a magnetic core, and can prevent cracking, chipping and change in magnetic properties due to an outer force exerted by an amorphous metal magnetic thin strip, which includes a composite magnetic core formed of a flanged cylindrical ferrite magnetic core having flange parts on both ends and an amorphous metal magnetic thin strip that is wound around the cylinder part of the ferrite magnetic core without going beyond the height of the flange parts, and a toroidal coil that is wound around the composite magnetic core (Patent Document 2).

However, the composite magnetic core of the electromagnetic device for a noise filter described in Patent Document 2 has a problem that it is difficult to subject the flanged cylindrical ferrite magnetic core having flange parts on both ends to powder compacting. Furthermore, the composite magnetic core is a magnetic core in which the amorphous metal magnetic thin strip is wound around the ferrite magnetic core, and the coil that is wound around the composite magnetic core is wound around the ferrite magnetic core as a toroidal coil always in contact with the ferrite magnetic core without being brought into contact with the amorphous metal magnetic thin strip. Thus, the shape of the composite magnetic core is limited to a specific shape, such as a doughnut shape, that is capable of toroidal winding. Furthermore, when a coil is intended to be wound around the outer periphery of the composite magnetic core as a rod-like coil, the coil is directly brought into contact with the amorphous metal magnetic thin strip, and thus there are problems that the amorphous metal magnetic thin strip easily cracks and wires are difficult to wind, and that the magnetic properties are deteriorated due to the stress during the winding.

Furthermore, a method for producing a soft magnetic composite powder having the following constitution is known, paying attention to the fact that electric insulation in a soft magnetic powder can be ensured and the molding processability can be improved by using a composite powder formed by coating at least a part of the surface of a soft magnetic powder with an inorganic insulating material, and fusion-bonding a resin material to the inorganic insulating material. That is, there is known a soft magnetic composite powder including a soft magnetic powder whose surface is coated with an inorganic insulating layer formed of an inorganic insulating material, and a resin material that is fusion-bonded to the surface of the inorganic insulating layer so as to partially coat the surface of the soft magnetic powder, the soft magnetic composite powder containing 0.3 to 6% by weight of the inorganic insulating material, 3 to 8% by weight of the resin material, and the soft magnetic powder as the remainder (Patent Document 3).

Furthermore, there is also known a powder magnetic core formed by compression-molding a mixture of a mixed powder formed by mixing an amorphous soft magnetic fine powder with an amorphous soft magnetic powder, and a binder, so as to obtain a powder magnetic core having a high magnetic permeability including, as a material, a mixed powder of an amorphous soft magnetic powder having a relatively large average particle size and a fine amorphous soft magnetic fine powder having an average primary particle size of about 1 μm or less, wherein the amorphous soft magnetic powder is formed of particles mainly having an amorphous phase and having an average particle size of 8 μm or more, the amorphous soft magnetic fine powder is formed of spherical particles mainly having an amorphous phase and having an average primary particle size of 0.1 μm or more and 1.5 μm or less, and the mixing ratio of the amorphous soft magnetic fine powder to the amorphous soft magnetic powder is 2% by weight or more and 40% by weight or less (Patent Document 4).

A powder magnetic core obtained by compression-molding an amorphous powder having been treated to have an insulating coating is excellent because it has a low loss equivalent to that of a ferrite magnetic core, and a high saturated magnetic flux density. However, the magnetic permeability of the powder magnetic core is lowered since an insulating coating is formed on the surface of the amorphous powder. Therefore, a result was obtained that an amorphous powder magnetic core having a higher compact density has a higher specific magnetic permeability.

When powder compacting is conducted by using the soft magnetic composite powder described in Patent Document 3 and using an amorphous powder having an insulating coating and having a particle size distribution on a normal distribution of an average particle size of about 50 μm, the density is increased to some extent even if the molding pressure is increased. However, the amorphous powder is poor in plastic deformability, and thus a high density article is difficult to obtain. Therefore, there is a problem that the specific magnetic permeability of the powder magnetic core remains about 50 despite the very high specific magnetic permeability of the amorphous powder itself of about several hundreds of thousands.

In the case where two kinds of soft magnetic powders having different particle sizes described in Patent Document 4 are mixed, the compact density is increased to some extent, but the improvement is not sufficient for the following reason.

When microparticles of an amorphous powder are present, the microparticles enter into a gap (clearance) of a molding mold during powder compacting, and cause molding troubles such as mold breakage. Furthermore, in the case of a mixed powder of powders having different average particle sizes, there is a problem that it is difficult to transport the mixed powder while keeping the particle size distribution during the flow of the powder, and thus the particle size distribution significantly changes before injection from a hopper to a mold, and thus it is impossible to obtain an amorphous powder magnetic core that can increase the compact density and can improve the magnetic permeability.

### PRIOR ART DOCUMENTS

### Patent Documents

Patent Document 1: Japanese Patent No. 4763609

Patent Document 2: JP 5-55061 A

Patent Document 3: Japanese Patent No. 4452240

Patent Document 4: JP 2012-129384 A

### SUMMARY OF INVENTION

### Problem to be Solved by the Invention

The present invention was made so as to address such problems, and aims at providing a magnetic core part and a magnetic element by which failures such as cracks do not occur in a molded article even in a magnetic core part containing 90% by mass or more of an amorphous metal powder, and thus a sufficient mechanical strength can be obtained, and a method for producing the magnetic core part. Furthermore, the present invention aims at providing a magnetic core part (an amorphous powder magnetic core) by which a high density and a high magnetic permeability can be obtained, and a method for producing the magnetic core part.

### Means for Solving the Problem

The magnetic core part of the present invention is a magnetic core part formed by thermoset molding a magnetic powder and a thermosetting binder resin, the magnetic powder being at least one magnetic powder selected from an amorphous metal powder alone and an amorphous metal powder coated with an insulating material, the magnetic core part containing the magnetic powder in an amount of 90% by mass or more and 99% by mass or less with respect to the total amount of the magnetic powder and the thermosetting binder resin.

Furthermore, the thermosetting binder resin is an epoxy resin that is cured by a latent curing agent.

Furthermore, either one of a pressurized powder-molded magnetic substance and a pressurized powder magnet-molded article is insert-molded in a composite magnetic powder of the magnetic powder and the thermosetting binder resin.

The magnetic element of the present invention includes the magnetic core part of the present invention and a coil wound around the magnetic core part, which is incorporated in an electronic device circuit.

The method of the present invention for producing the magnetic core part includes: a mixing step of dry-mixing the magnetic powder and the thermosetting binder resin at a temperature equal to or higher than the softening temperature of the binder resin and lower than the thermal curing initiation temperature of the binder resin; a pulverizing step of pulverizing an agglomerated cake produced in the mixing step at room temperature to give a composite magnetic powder; a compression molding step of forming the composite magnetic powder into a compression-molded article by using a mold; and a curing step of thermally curing the compression-molded article at a temperature equal to or higher than the thermal curing initiation temperature of the binder resin.

Furthermore, the compression molding step is a step of inserting either one of a pressurized powder-molded magnetic substance and a pressurized powder magnet-molded article in the composite magnetic powder, followed by compression molding.

Furthermore, in the production method, the amorphous metal powder coated with the insulating material is secondary particles formed of at least two kinds of amorphous metal powders having different average particle sizes and different particle size distributions, the secondary particles contain an amorphous metal powder having a large average particle size as central particles, and an amorphous metal powder having a smaller average particle size than that of the central particles is adhered to surfaces of the central particles.

Furthermore, the particle size distribution of the amorphous metal powder that serves as the central particles and the particle size distribution of the amorphous metal powder adhered to the surfaces of the central particles have, in a particle size distribution diagram in which abundance rates are plotted on the vertical axis and particle sizes are plotted on the horizontal axis, at least 10% or less of a part in which the particle size distributions overlap.

The magnetic core part (the amorphous powder magnetic core) of the present invention is an amorphous powder magnetic core formed by compression-molding an amorphous metal powder whose surface is coated with an insulating layer, the amorphous metal powder being secondary particles formed of at least two kinds of amorphous metal powders having different average particle sizes and different particle size distributions, the secondary particles containing an amorphous metal powder having a large average particle size as central particles, an amorphous metal powder having a smaller average particle size than that of the central particles being adhered to surfaces of the central particles.

Furthermore, the amorphous powder magnetic core has a density of 5.6 or more and a specific magnetic permeability of 60 or more.

In the amorphous powder magnetic core, the particle size distribution of the amorphous metal powder that serves as the central particles and the particle size distribution of the amorphous metal powder adhered to the surfaces of the central particles have, in a particle size distribution diagram in which abundance rates are plotted on the vertical axis and particle sizes are plotted on the horizontal axis, at least 10% or less of a part in which the particle size distributions overlap.

Furthermore, the insulating layer of the amorphous metal powder is formed of an inorganic insulating layer formed of at least an inorganic insulating material.

The method for producing the amorphous powder magnetic core includes the steps (1) to (3) mentioned below:

(1) a step of producing an amorphous metal powder having the inorganic insulating layer on each of surfaces of the at least two kinds of amorphous metal powders having different average particle sizes and different particle size distributions,

(2) a step of forming secondary particles by mixing the amorphous metal powder that has a large average particle size and that serves as central particles with the amorphous metal powder that has a smaller average particle size than that of the central particles, followed by granulation, and

(3) a compression molding step of compression-molding the secondary particles.

### Effect of the Invention

The magnetic core part of the present invention is obtained by thermoset molding an amorphous metal powder with a thermosetting binder resin, and contains the magnetic powder in an amount of 90% by mass or more and 99% by mass or less, and thus can have a magnetic permeability approximately the same as that of a fired compact of a magnetic powder alone. Furthermore, since the magnetic core part can impart a high inductance value even at a large current and a high frequency of several thousands of kilohertz or more, the magnetic core part and the magnetic element can be miniaturized.

Since the method of the present invention for producing the magnetic core part includes a compression molding step of forming the composite magnetic powder into a compression-molded article by using a mold, a mold that is less expensive and has a longer life than that used in injection molding can be used.

Since the magnetic core part (an amorphous powder magnetic core) of the present invention is formed by compression-molding secondary particles that are formed by granulating into a predetermined structure at least two kinds of amorphous metal powders having different particle sizes, it can improve the density and specific magnetic permeability of the amorphous powder magnetic core. Specifically, the density can be 5.6 or more, and the specific magnetic permeability can be 60 or more.

### BRIEF DESCRIPTION OF THE DRAWINGS

FIG. 1 is a process chart for producing a magnetic core part.

FIG. 2 is a process chart of insert molding.

FIG. 3 is a photograph showing a sample for the measurement of magnetic properties.

FIG. 4 is a graph showing a frequency dependency of the specific magnetic permeability of the magnetic core part.

FIG. 5 is a graph showing direct current superimposition characteristics of the magnetic core part.

FIG. 6 is a graph showing the radial crushing strength of the magnetic core part.

FIGS. 7(a) to 7(c) are each a drawing showing an insert-molded magnetic core part.

FIG. 8 is a graph showing a frequency dependency of the inductance of the magnetic core part.

FIG. 9 is a graph showing a frequency dependency of the inductance of the magnetic core part.

FIG. 10 is a particle size distribution chart of an insulated amorphous metal powder.

FIG. 11 is a photograph showing secondary particles after granulation.

### MODE FOR CARRYING OUT THE INVENTION

When a magnetic core part is to be produced by sintering an amorphous metal powder alone so as to achieve miniaturization, increase of frequency and increase of current of electric and electronic devices, a molding pressure of about 15 t/cm² is required during compression molding. However, by blending a thermosetting binder resin, the molding pressure during the thermoset molding was decreased to about 2 t/cm² despite the fact that the magnetic properties of the magnetic core part are approximately identical with those of the amorphous metal powder alone. Furthermore, even in the case where the magnetic core part contains the magnetic powder such as an amorphous metal in an amount of 90% by mass or more, failures such as cracks did not occur, and a sufficient mechanical strength was obtained. The present invention is based on such finding.

The magnetic powder that forms the magnetic core part is an amorphous metal powder to which a ferromagnetic element such as iron, cobalt, nickel, and gadolinium has been added. Examples of the amorphous metal powder include iron alloy-based, cobalt alloy-based and nickel alloy-based amorphous metal powders, and mixed alloy-based amorphous metal powders of these alloys.

As the magnetic powder, either of an amorphous metal powder alone or an amorphous metal powder coated with an insulating material (an insulating layer) can be used. As the insulating material, metal oxides such as Al₂O₃, Y₂O₃, MgO and ZrO₂, glass, or mixtures thereof can be used.

As the method for forming the insulating coating, powder coating processes such as a mechanofusion process, wet thin film preparation processes such as an electroless plating process and a sol-gel process, or dry thin film preparation processes such as sputtering can be used.

The magnetic powder before molding, which is used as a raw material, preferably has a particle size of 300 μm or less, and a mixed magnetic powder of powders having a plurality of particle sizes that contains a large amount of microparticles is more preferable.

Examples of the thermosetting binder resin that forms the magnetic core part include an epoxy resin, a phenolic resin, a urea resin, and an unsaturated polyester resin. Among these, an epoxy resin is preferably used. The binder resin is used for insulation and binding.

The epoxy resin that can be used in the present invention is preferably a resin that can be used as an epoxy resin for adhesion and has a softening temperature of 100 to 120° C. For example, any epoxy resin can be used as long as it is solid at room temperature, but turns into a paste at 50 to 60° C. and flows at 130 to 140° C., and initiates a curing reaction when further heated. The curing reaction begins at around 120° C., but the temperature at which the curing reaction is completed within a practical curing time, such as 2 hours, is preferably 170 to 190° C. In this temperature range, the curing time is 45 to 80 minutes.

Examples of the resin component of the epoxy resin include a bisphenol A type epoxy resin, a bisphenol F type epoxy resin, a bisphenol S type epoxy resin, a hydrogenated bisphenol A type epoxy resin, a hydrogenated bisphenol F type epoxy resin, a stilbene type epoxy resin, a triazine skeleton-containing epoxy resin, a fluorene skeleton-containing epoxy resin, an alicyclic epoxy resin, a novolak type epoxy resin, an acrylic epoxy resin, a glycidylamine type epoxy resin, a triphenolphenolmethane type epoxy resin, an alkyl-modified triphenolmethane type epoxy resin, a biphenyl type epoxy resin, a dicyclopentadiene skeleton-containing epoxy resin, a naphthalene skeleton-containing epoxy resin, and an arylalkylene type epoxy resin.

The curing agent component of the epoxy resin is a latent epoxy curing agent. By using the latent epoxy curing agent, the softening temperature can be set at 100 to 120° C. and the curing temperature can be set at 170 to 190° C., whereby an insulating coating can be formed on an iron powder, followed by compression molding and thermal curing.

Examples of the latent epoxy curing agent include dicyandiamide, a trifluoroboron-amine complex, and an organic acid hydrazide. Among these, dicyandiamide, which conforms to the above-mentioned curing conditions, is preferable.

Furthermore, a curing accelerator such as a tertiary amine, imidazole and an aromatic amine can be blended in the magnetic core part together with the latent epoxy curing agent.

The epoxy resin containing the latent curing agent, which can be used in the present invention, contains the latent curing agent so that the curing conditions are 2 hours at 160° C., 80 minutes at 170° C., 55 minutes at 180° C., 45 minutes at 190° C., and 30 minutes at 200° C.

The blending ratios of the magnetic powder and the epoxy resin are 90% by mass or more and 99% by mass or less of the magnetic powder and 1% by mass or more and 10% by mass or less of the epoxy resin with respect to the total amount of these. This is because when the ratio of the epoxy resin is less than 1% by mass, the insulating coating is difficult to form, whereas when the ratio of the epoxy resin is more than 10% by mass, the magnetic properties are deteriorated, and a resin-rich coarse agglomerate is produced.

The magnetic core part can be produced by thermoset molding a mixture of the magnetic powder and the epoxy resin. Furthermore, by disposing a pressurized powder-molded magnetic substance or a pressurized powder magnet-molded article in a mold, and conducting insert molding by using the mixture of the magnetic powder and the epoxy resin, a magnetic core part having the pressurized powder-molded magnetic substance or the pressurized powder magnet-molded article inside and having an amorphous metal magnetic substance as an outer periphery can be produced.

The pressurized powder-molded magnetic substance is a magnetic substance obtained by blending a binder resin in a magnetic powder as necessary and molding the magnetic powder. Examples of the magnetic powder include metal powders, pure iron-based soft magnetic materials such as an iron nitride powder, a Fe—Si—Al alloy (Sendust) powder, a Super Sendust powder, a Ni—Fe alloy (permalloy) powder, a Co—Fe alloy powder, pure iron-based soft magnetic materials, iron group alloy-based soft magnetic materials such as a Fe—Si—B-based alloy powder, ferrite-based materials, amorphous materials, and microcrystalline materials. The amorphous material may be the same as or different from the above-mentioned amorphous metal magnetic substance. Furthermore, as the insulating material on the surface of the magnetic powder, those used in the amorphous metal powder can be used.

Where necessary, a binder resin can be added as a binder component to the pressurized powder-molded magnetic substance. Examples of the binder resin used include thermoplastic resins such as polyolefins such as polyethylene and polypropylene, polyvinyl alcohol, polyethylene oxide, polyphenylene sulfide (PPS), liquid crystal polymers, polyether ether ketone (PEEK), polyimides, polyetherimides, polyacetals, polyethersulfones, polysulfones, polycarbonates, polyethylene terephthalate, polybutylene terephthalate, polyphenylene oxide, polyphthalamides, polyamides, and mixtures thereof. Alternatively, the above-mentioned thermosetting resins can be used.

The pressurized powder magnet-molded article is a molded article obtained by increasing the packing density of the magnetic powder. A soft magnetic material powder is used for the pressurized powder-molded magnetic substance, whereas a hard magnetic material powder is used for the pressurized powder magnet-molded article. Examples of the hard magnetic material powder include a ferrite-based magnet powder, rare earth-based magnet powders such as Fe—Nd—B-based and Sm—Co-based magnet powders, and an Al—Ni—Co-based alnico magnet powder. As the binder resin, the resins used in the pressurized powder-molded magnetic substance can be used. Furthermore, as the insulating material at the hard magnetic material powder surface, those used in the amorphous metal powder can be used. Furthermore, the pressurized powder magnet-molded article can be magnetized before use.

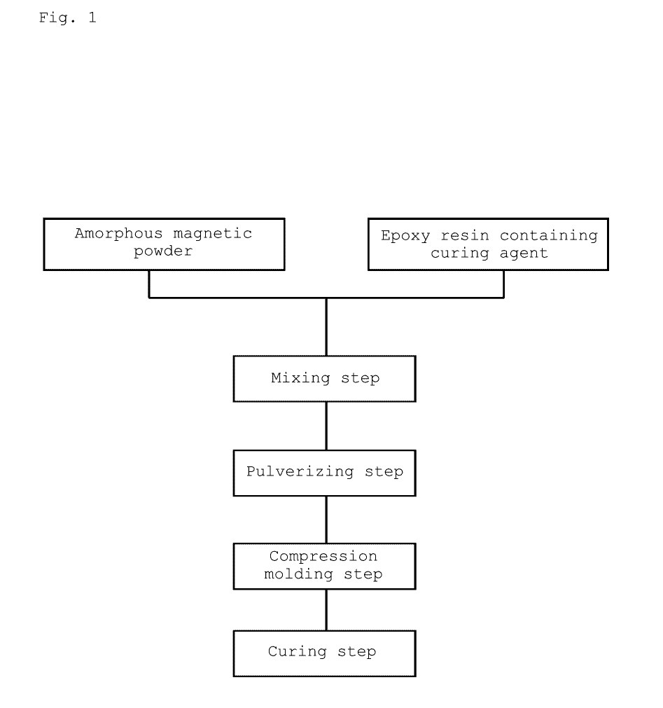

The method for producing the magnetic core part will be described with reference to FIG. 1. FIG. 1 is a process chart for producing a magnetic core part.

An amorphous metal powder, which is the magnetic substance mentioned above, and an epoxy resin already containing the above-mentioned latent curing agent are prepared. The amorphous metal powder has been adjusted in advance by a classifier so that it is made into particles that pass through an 80-mesh sieve but do not pass through a 325-mesh sieve.

By the mixing step, the amorphous metal powder and the epoxy resin are dry-mixed at a temperature equal to or higher than the softening temperature of the epoxy resin and lower than the thermal curing initiation temperature of the epoxy resin. In this mixing step, firstly, the amorphous metal powder and the epoxy resin are sufficiently mixed at room temperature by using a blender or the like. Subsequently, the mixture is put in a mixer such as a kneader and hot-mixed at the softening temperature of the epoxy resin (100 to 120° C.). By this step of hot mixing, an insulating coating of the epoxy resin is formed on the surface of the amorphous metal powder. At this stage, the epoxy resin is uncured.

The contents of the mixer such as a kneader that have been hot-mixed therein are in an agglomerated cake form. The pulverizing step is a step of pulverizing the agglomerated cake at room temperature and then sieving the resulting product to thereby obtain a composite magnetic powder having an insulating film of the epoxy resin on the surface. The pulverization is preferably conducted by a Henschel mixer, and the sieving preferably gives a particle size that passes through a 60-mesh sieve.

The mold used in the compression molding step may be any mold capable of cold molding or hot molding. The cold molding herein refers to compression molding without heating, and the hot molding herein refers to compression molding at a temperature of about the softening temperature of the epoxy resin (100 to 120° C.) for several minutes. By using the hot molding, the density of the resin molded article is increased.

In the case where the magnetic core part has either one of a pressurized powder-molded magnetic substance and a pressurized powder magnet-molded article (hereinafter referred to as a pressurized powder-molded magnetic substance or the like) inside, compression molding is conducted with the pressurized powder-molded magnetic substance or the like being retained in the mold, and the composite magnetic powder being disposed around the pressurized powder-molded magnetic substance or the like in the compression molding step.

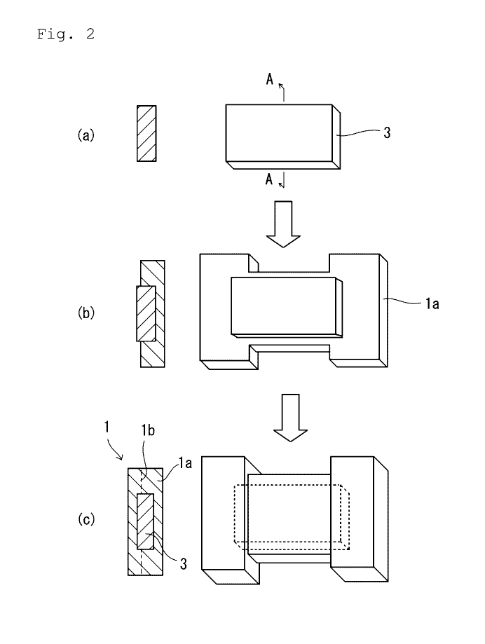

An example of the compression molding step is shown in FIG. 2. FIG. 2 is a process chart of insert molding of the pressurized powder-molded magnetic substance or the like, and the left side of FIG. 2 shows the cross-sectional views taken along the line A-A of the right side of FIG. 2.

A pressurized powder-molded magnetic substance or the like 3 is prepared (FIG. 2(a)). The pressurized powder-molded magnetic substance or the like 3 is disposed inside a mold (not shown in the drawing), and a composite magnetic powder 1a is charged around the pressurized powder-molded magnetic substance or the like 3, and the pressurized powder-molded magnetic substance or the like 3 and the composite magnetic powder 1a are compressed in the mold (FIG. 2(b)). Subsequently, the composite magnetic powder 1a is charged into the mold so as to cover the entirety of the pressurized powder-molded magnetic substance or the like 3, and the composite magnetic powder 1a and the pressurized powder-molded magnetic substance or the like 3 are compressed in the mold (FIG. 2(c)). An abutting surface 1b of the composite magnetic powder 1a is integrated in the compression molding step and the subsequent curing step.

The molded article removed from the mold is cured by heating at a temperature of 170 to 190° C. for 45 to 80 minutes. This is because a long time is required for the curing at a temperature lower than 170° C., and the molded article starts to deteriorate at a temperature higher than 190° C. It is preferable that the thermal curing is conducted in a nitrogen atmosphere.

After the thermal curing, cutting, barreling, an antirust treatment and the like are conducted as necessary, whereby a magnetic core part 1 can be obtained.

The magnetic element of the present invention includes a coil formed by winding a wire around the magnetic core part, and thus has an inductor function. The magnetic element is incorporated in an electronic device circuit.

As the winding wire, a copper enameled wire can be used. Examples of the copper enameled wire include a urethane wire (UEW), a formal wire (PVF), a polyester wire (PEW), a polyesterimide wire (EIW), a polyamideimide wire (AIW), a polyimide wire (PIW), double-coated wires including these wires in combination, self-welding wires, and litz wires. As for the cross-sectional shape of the copper enameled wire, a round wire or a square wire can be used.

As the winding form of a coil, helical winding and toroidal winding can be adopted. In the case of a micromini magnetic core part, a columnar core, a prismatic columnar core and a plate-like core, which are not a doughnut-shaped core used in a core of a toroidal coil, can be used.

The magnetic core part and/or magnetic element of the present invention described above can be used as a core part of a soft magnetic material for use in power circuits, filter circuits and switching circuits of automobiles including motorcycles, industrial devices and medical devices, such as core parts and magnetic elements of inductors, transformers, antennas, choke coils, and filters. Furthermore, the magnetic core part and/or magnetic element can also be used as magnetic cores and magnetic elements of surface-mounted parts.

### EXAMPLE 1

In a blender, 1,940 g of an amorphous metal magnetic powder (a Fe—Si—B-based amorphous metal) having a particle size of 150 μm or less and a median diameter D₅₀ of 50 μm, and 60 g of an epoxy resin powder containing dicyandiamide as a curing agent were mixed at room temperature for 10 minutes. This mixture was put in a kneader, and kneaded under heating at 110° C. for 12 minutes. The blending ratio of the amorphous metal magnetic powder was 97% by mass. An agglomerated cake was taken out of the kneader and cooled, and then pulverized in a pulverizer to give a powder having a particle size that passes through a 60-mesh sieve. Subsequently, the powder was compression-molded at room temperature by using a mold at a molding pressure of 2 t/cm². A compression-molded article was taken out of the mold, and subjected to thermal curing under conditions of a temperature of 180° C. for 1 hour in the air, whereby a plane cylindrical magnetic core part having an inner diameter of 20 mm, an outer diameter of 30 mm and a height of 5 mm was produced. The magnetic core part had a density of 4.91 g/cm³.

As the magnetic properties of the obtained magnetic core part, the frequency dependency of the specific magnetic permeability and the direct current superimposition characteristics were measured. Furthermore, as the mechanical properties, the radial crushing strength was measured.

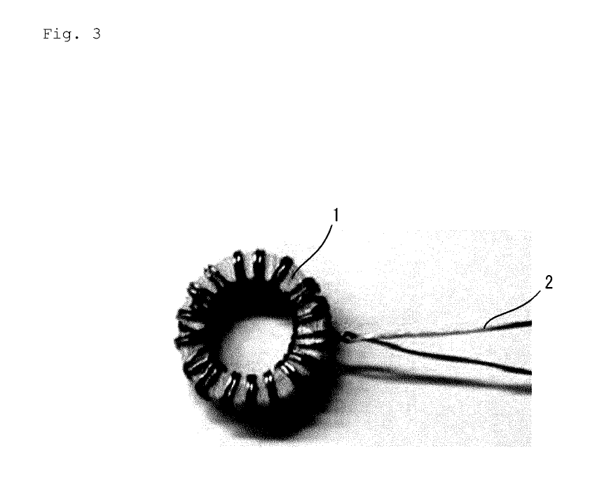

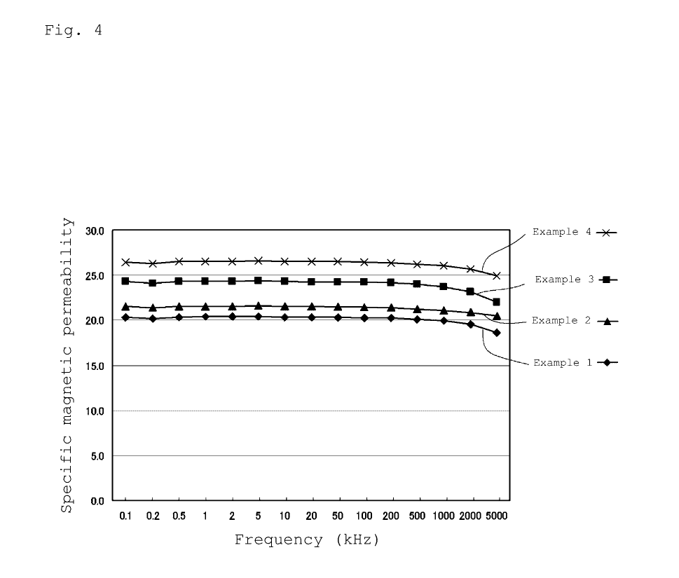

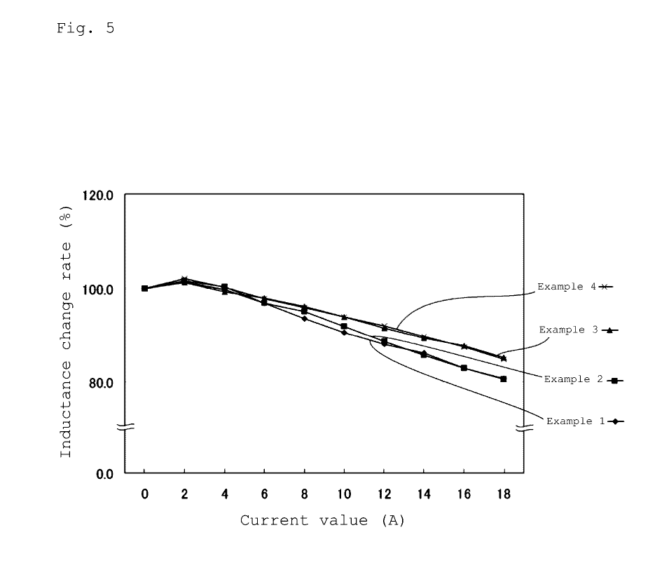

The sample for the measurement of magnetic properties is shown in FIG. 3. The sample for the measurement of magnetic properties is an inductor as a magnetic element, which was obtained by winding a polyester insulating copper enameled wire 2 having a diameter of 0.80 mm around a plane cylindrical magnetic core part 1 by 30 to 35 turns so as to have an inductance value of 10 μH. Using this inductor, the frequency dependency of the specific magnetic permeability was measured, and the inductance value when a direct current was superimposed on the coil was measured by using an LCR meter at a frequency of 1 kHz. The direct current superimposition characteristics are represented by a change rate (%) with the inductance value at a current value of 0 being deemed as 100. The results are shown in FIGS. 4 and 5.

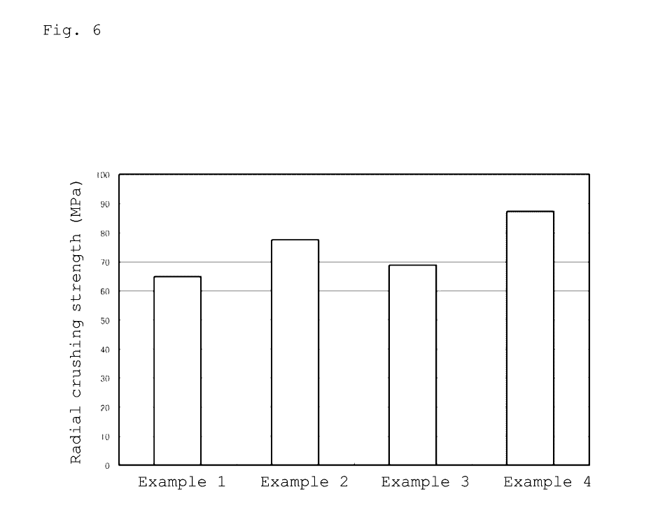

Furthermore, the radial crushing strength was measured by using a plane cylindrical magnetic core part alone by a tensile compression test at a load velocity of 1 mm/min. The results are shown in FIG. 6.

### EXAMPLE 2

Using the powder having a particle size that passes through a 60-mesh sieve obtained from the amorphous metal magnetic powder and the epoxy resin powder used in Example 1, the powder was subjected to thermal curing under conditions of a temperature of 180° C. for 1 hour in an air atmosphere in a similar manner to that of Example 1, except that the molding conditions were changed to a temperature of 110° C. and a time of 5 minutes when the magnetic core part was formed into a compression-molded article, whereby a plane cylindrical magnetic core part having an inner diameter of 20 mm, an outer diameter of 30 mm and a height of 5 mm was produced. The magnetic core part had a density of 5.17 g/cm³.

The magnetic properties and mechanical properties of the obtained magnetic core part were measured by similar methods to those in Example 1. The results are shown in FIGS. 4 to 6.

### EXAMPLE 3

In a blender, 1,940 g of an amorphous metal magnetic powder having a particle size distribution to which a fine powder had been added, and having a particle size of 300 μm or less as an amorphous metal magnetic powder, and 60 g of an epoxy resin powder containing dicyandiamide as a curing agent were mixed at room temperature for 10 minutes. This mixture was put in a kneader, and kneaded under heating at 110° C. for 12 minutes. An agglomerated cake was taken out of the kneader and cooled, and then pulverized in a pulverizer to give a powder having a particle size that passes through a 28-mesh sieve. Subsequently, the powder was compression-molded at room temperature by using a mold at a molding pressure of 2 t/cm². A compression-molded article was taken out of the mold, and subjected to thermal curing under conditions of a temperature of 180° C. for 1 hour in an air atmosphere, whereby a plane cylindrical magnetic core part having an inner diameter of 20 mm, an outer diameter of 30 mm and a height of 5 mm was produced. The magnetic core part had a density of 5.12 g/cm³.

The magnetic properties and mechanical properties of the obtained magnetic core part were measured by similar methods to those in Example 1. The results are shown in FIGS. 4 to 6.

### EXAMPLE 4

Using the powder having a particle size that passes through a 28-mesh sieve obtained from the amorphous metal magnetic powder and the epoxy resin powder used in Example 3, the powder was subjected to thermal curing under conditions of a temperature of 180° C. for 1 hour in an air atmosphere in a similar manner to that of Example 3, except that the molding conditions were changed to a temperature of 110° C. and a time of 5 minutes when the magnetic core part was formed into a compression-molded article, whereby a plane cylindrical magnetic core part having an inner diameter of 20 mm, an outer diameter of 30 mm and a height of 5 mm was produced. The magnetic core part had a density of 5.33 g/cm³.

The magnetic properties and mechanical properties of the obtained magnetic core part were measured by similar methods to those in Example 1. The results are shown in FIGS. 4 to 6.

### EXAMPLE 5

In a blender, 1,960 g of an amorphous metal magnetic powder (a Fe—Si—B-based amorphous metal) having a particle size of 150 μm or less and a median diameter D₅₀ of 50 μm, and 40 g of an epoxy resin powder containing dicyandiamide as a curing agent were mixed at room temperature for 10 minutes. This mixture was put in a kneader, and kneaded under heating at 110° C. for 12 minutes. The blending ratio of the amorphous metal magnetic powder was 98% by mass. An agglomerated cake was taken out of the kneader and cooled, and then pulverized in a pulverizer to give a powder having a particle size that passes through a 60-mesh sieve. Subsequently, the powder was compression-molded under conditions of a temperature of 110° C. and a time of 5 minutes by using a mold at a molding pressure of 2 t/cm². A compression-molded article was taken out of the mold, and subjected to thermal curing under conditions of a temperature of 180° C. for 1 hour in an air atmosphere, whereby a plane cylindrical magnetic core part having an inner diameter of 20 mm, an outer diameter of 30 mm and a height of 5 mm was produced. This magnetic core part was capable of being used without breakage.

### EXAMPLE 6

In a blender, 1,980 g of an amorphous metal magnetic powder (a Fe—Si—B-based amorphous metal) having a particle size of 150 μm or less and a median diameter D₅₀ of 50 μm, and 20 g of an epoxy resin powder containing dicyandiamide as a curing agent were mixed at room temperature for 10 minutes. This mixture was put in a kneader, and kneaded under heating at 110° C. for 12 minutes. The blending ratio of the amorphous metal magnetic powder was 99% by mass. An agglomerated cake was taken out of the kneader and cooled, and then pulverized in a pulverizer to give a powder having a particle size that passes through a 60-mesh sieve. Subsequently, the powder was compression-molded under conditions of a temperature of 110° C. and a time of 5 minutes by using a mold at a molding pressure of 2 t/cm². A compression-molded article was taken out of the mold, and subjected to thermal curing under conditions of a temperature of 180° C. for 1 hour in an air atmosphere, whereby a plane cylindrical magnetic core part having an inner diameter of 20 mm, an outer diameter of 30 mm and a height of 5 mm was produced. This magnetic core part was capable of being used without breakage.

### EXAMPLE 7

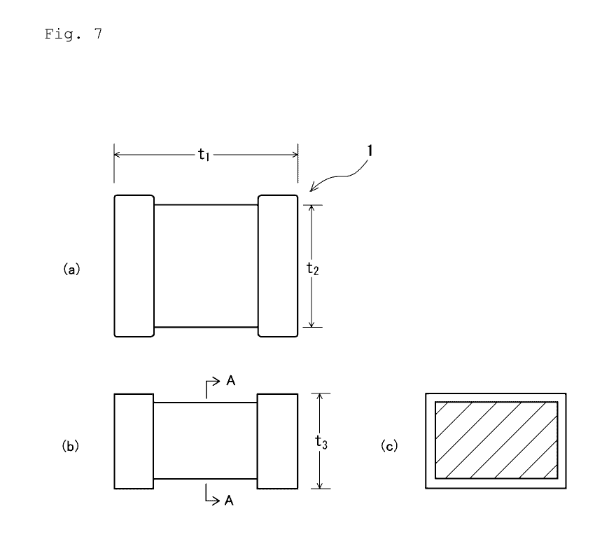

An example of a magnetic core part in which a ferrite core has been insert-molded is shown in FIG. 7. FIG. 7 (a) shows a plan view, FIG. 7 (b) shows a front view, and FIG. 7 (c) shows a cross-sectional view taken along the line A-A. A ferrite core (not shown in the drawing) has been insert-molded inside a magnetic core part 1.

The powder having a particle size that passes through a 28-mesh sieve obtained from the amorphous metal magnetic powder and the epoxy resin powder used in Example 3 was put in a mold, a ferrite core was subsequently disposed so that the upper part thereof is exposed, and the powder was compression-molded under conditions of a temperature of 110° C., a time of 5 minutes and a molding pressure of 2 t/cm². Thereafter, the powder used in Example 3 was put in the mold so as to cover the entirety of the ferrite core, and the powder and the ferrite core were compression-molded under conditions of a temperature of 110° C., a time of 5 minutes and a molding pressure of 2 t/cm². The resulting product was subjected to thermal curing under conditions of a temperature of 180° C. for 1 hour in an air atmosphere, whereby a magnetic core part 1 for a chip inductor was produced, in which the ferrite core had been insert-molded, and which had a long diameter (t₁) of 4.6 mm, a short diameter (t₂) of 3.06 mm, and a height (t₃) of 2.36 mm.

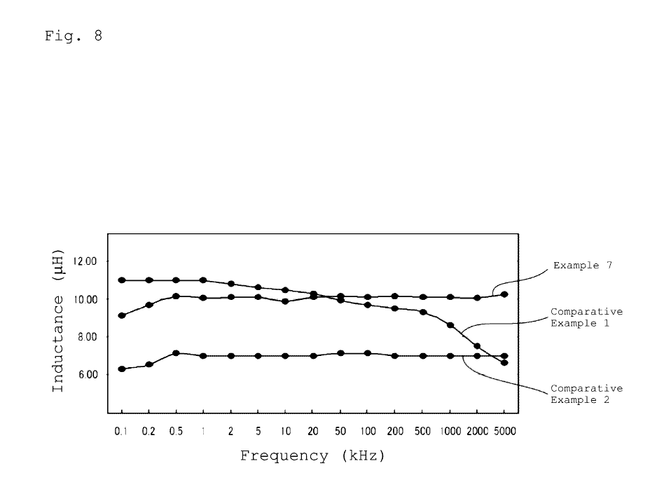

A polyester insulating copper enameled wire having a diameter of 0.80 mm was wound around the obtained magnetic core part 1 for a chip inductor by 27 turns to produce a chip inductor. Using this inductor, the frequency dependency of the inductance was measured. The result is shown in FIG. 8.

### COMPARATIVE EXAMPLE 1

A chip inductor having a magnetic core part having an identical shape with that of Example 7 was produced from ferrite alone. The frequency dependency of the inductance was measured under identical conditions with those of Example 7. The result is shown in FIG. 8.

### COMPARATIVE EXAMPLE 2

A chip inductor having an identical shape and identical materials with those of Example 7 was produced by injection molding. The injection molding was conducted by using pellets for injection molding obtained by mixing 14 parts by mass of polyphenylenesulfide with 100 parts by mass of the amorphous metal powder used in Example 1. The frequency dependency of the inductance was measured under identical conditions with those of Example 7. The result is shown in FIG. 8.

### EXAMPLE 8

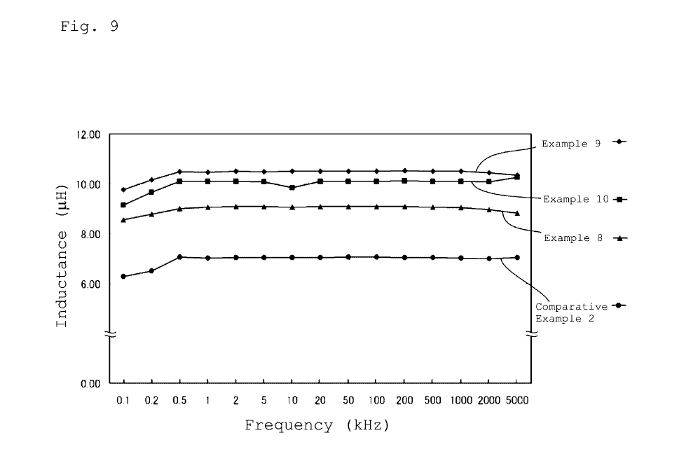

A chip inductor having an identical shape with that of Example 7 was produced by using identical materials and an identical method with those of Example 1, except that a ferrite core was not insert-molded. The frequency dependency of the inductance was measured under identical conditions with those of Example 7. The result is shown in FIG. 9.

### EXAMPLE 9

A magnetic core part for a chip inductor in which a ferrite core had been insert-molded was produced again using identical materials and an identical method with those of Example 8, except that the shape of the chip inductor was identical with that of Example 7. The frequency dependency of the inductance was measured under identical conditions with those of Example 7. The result is shown in FIG. 9.

### EXAMPLE 10

A chip inductor having an identical shape and identical materials with those of Example 7 was produced again. The frequency dependency of the inductance was measured under identical conditions with those of Example 7. The result is shown in FIG. 9.

The magnetic core part (amorphous powder magnetic core) of the present invention, by which a high density and a high magnetic permeability can be obtained, will be described below.

In the case where an amorphous metal powder having a particle size distribution in which particle sizes having an average particle size of about 50 μm were normally distributed was compression-molded, the limits of density and specific magnetic permeability of the amorphous powder magnetic core were 5.60 and 50, respectively, even when the compression molding pressure was increased. Furthermore, when the compression molding pressure was increased, particles having very small particle sizes were present due to the particle size distribution of the amorphous metal powder, and these particles having small particle sizes entered into the gap (clearance) of the mold during the compression molding, and caused molding troubles such as mold breakage. This is because the amorphous metal powder has a high hardness that is equal or more than that of a mold material.

Furthermore, when a mixed powder of amorphous metal powders having different particle sizes was used for the purpose of close packing so as to increase the density, there was a problem that it was difficult to transport the powder while keeping the particle size distribution during the flow of the powder, and thus the particle size distribution significantly changes before injection from a hopper to the mold. However, by granulating at least two kinds of amorphous metal powders having different average particle sizes and different particle size distributions to give secondary particles, and compression-molding the secondary particles, an amorphous powder magnetic core was obtained, in which the particle size distribution did not changed, and the amorphous powder magnetic core had a density of 5.6 or more and a specific magnetic permeability of 60 or more, which had been conventionally deemed as limits. The magnetic core part described below is based on such finding. Furthermore, this finding is also effective for compression molding of the amorphous metal powder in the magnetic core part containing a thermosetting binder resin.

The amorphous metal powder that can be used in the present invention is a soft magnetic substance. As mentioned above, iron alloy-based, cobalt alloy-based and nickel alloy-based amorphous metal powders, and mixed alloy-based amorphous metal powders of these alloys can be used as the amorphous metal powder.

Examples of the oxide for forming an insulating coating on each particle surface of the amorphous metal powder include, as mentioned above, oxides of insulating metals or semimetals such as Al₂O₃, Y₂O₃, MgO and ZrO₂, glass, and mixtures thereof. Among these, glass materials are preferable. Among the glass materials, low melting point glass is preferable. This is because these materials have a low softening temperature, and thus can be fusion-bonded to a soft magnetic amorphous alloy to thereby coat the surface.

The low melting point glass is not specifically limited as long as it does not react with the amorphous metal powder, and is softened at a temperature lower than the crystallization initiation temperature of the amorphous metal, preferably at about 550° C. or lower. For example, known low melting point glass such as lead-based glass such as PbO—B₂O₃-based glass, P₂O₅-based glass, ZnO—BaO-based glass, and ZnO—B₂O₃—SiO₂-based glass can be used. P₂O₅-based glass, which is lead-free glass and gives a low softening point, is preferable. As an example thereof, P₂O₅-based glass having a composition of 60 to 80% by mass of P₂O₅, 10% by mass or less of Al₂O₃, 10 to 20% by mass of ZnO, 10% by mass or less of Li₂O and 10% by mass or less of Na₂O can be used.

An example of a method for producing the insulating layer of the amorphous metal powder will be described below. Where necessary, a resin material can be added so as to increase the strength of the compression-molded article and improve the insulation.

As a method for coating the amorphous metal powder with an inorganic insulating material to form an inorganic insulating layer, as mentioned above, powder coating processes such as a mechanofusion process, wet thin film preparation processes such as an electroless plating process and a sol-gel process, or dry thin film preparation processes such as sputtering can be used. Among these, the powder coating process can be conducted by, for example, using the powder coating device described in JP 2001-73062 A. According to this method, the amorphous metal powder and the low melting point glass powder are subjected to a strong compression friction force, the amorphous metal powder and the low melting point glass powder are melt-bonded, and the glass powder particles are fusion-bonded, whereby an amorphous metal powder can be obtained, in which the surface of the amorphous metal powder is coated with a inorganic insulating layer formed of the low melting point glass.

Furthermore, it is necessary that the composition of the insulated amorphous metal powder is decided so that the amount of the inorganic insulating material is 0.3 to 6% by weight and the remainder is the amorphous metal powder, more preferably, the amount of the inorganic insulating material is 0.4 to 3% by weight and the remainder is the amorphous metal powder, further preferably, the amount of the inorganic insulating material is 0.4 to 1% by weight and the remainder is the amorphous metal powder. Where necessary, 0.1 to 0.5% by weight of zinc stearate, and a lubricant of a stearic acid salt such as calcium stearate can also be added. Furthermore, where necessary, warm molding, mold lubrication molding, or a molding method combining these can be utilized.

For the insulated amorphous metal powder, at least two kinds of amorphous metal powders having different average particle sizes and different particle size distributions are prepared. As the amorphous metal powders, amorphous metal powders of the same kind, or different amorphous metal powders can be used. Amorphous metal powders of the same kind are preferable.

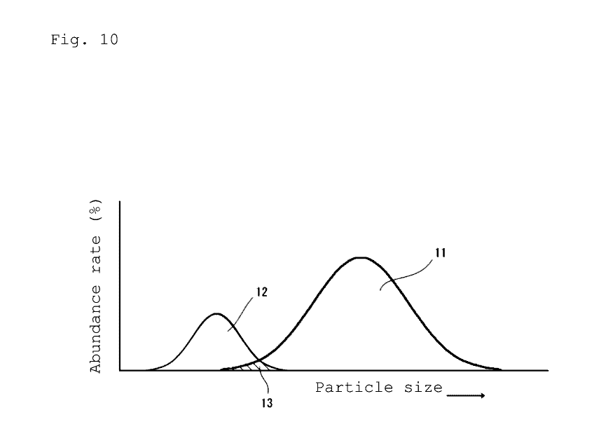

The distribution of the two kinds of insulated amorphous metal powders is shown in FIG. 10. FIG. 10 is a particle size distribution chart of insulated amorphous metal powders each having a normal distribution. The average particle sizes are represented by peaks.

As shown in FIG. 10, insulated amorphous metal powders 11 and 12, which preferably have clearly different peaks in the particle size distribution chart in which abundance rates are plotted on the vertical axis and particle sizes are plotted on the horizontal axis, are prepared.

Preferably, two kinds, which are large and small, of insulated amorphous metal powders 11 and 12, in which a part 13 where the particle size distributions overlap is at least 10% or less, are prepared. Herein, 10% is the area of the region where the distributions overlap with respect to the area of the entirety of the clearly different peaks including the overlapped part, in the case where the powder having a larger average particle size and the powder having a smaller average particle size are totalized.

In the present invention, a preferable average particle size of the amorphous metal powder 11 having a larger average particle size is 40 μm to 100 μm, and a preferable average particle size of the amorphous metal powder 12 having a smaller average particle size is 1 μm to 10 μm.

Furthermore, the blending ratio of the amorphous metal powder 11 and the amorphous metal powder 12 is preferably as follows: the blending ratio of the amorphous metal powder 12 is 18 parts by mass to 55 parts by mass when the blending ratio of the amorphous metal powder 11 is deemed as 100 parts by mass.

By mixing and granulating the two kinds of powders, secondary particles are formed. The method for the granulation is a self-granulation process such as tumbling fluidized granulation, a forced granulation process such as spray drying, or the like, and the granulation is preferably conducted by a tumbling fluidized granulation process.

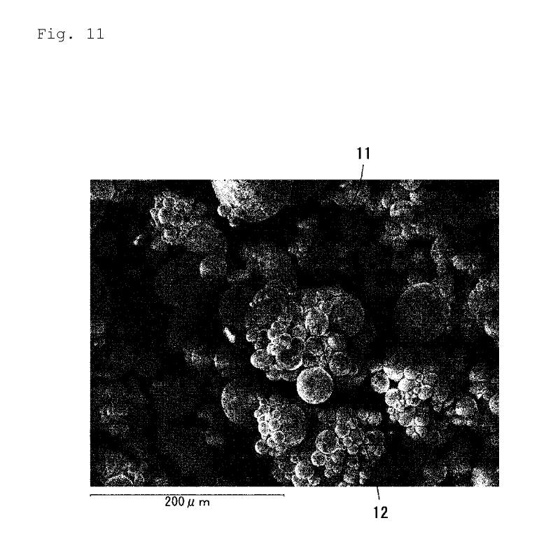

The secondary particles after the granulation are shown in FIG. 11. The obtained secondary particles are particles in which the amorphous metal powder 12 having a small particle size is attached to the periphery of the amorphous metal powder 11 having a large average particle size. In the granulation, a binder may be added as necessary. As the binder, polyvinyl alcohol, polyvinyl butyral, hydroxypropyl cellulose or hydroxypropyl methyl cellulose is preferably used. The binder may be one obtained by modifying each of these components.

In the present invention, the secondary particles are filled in a predetermined mold and compression-molded. For example, a powder of the secondary particles is filled in a mold, the powder is press-molded at a predetermined pressure, and the molded pressurized powder is fired to burn out the resin, whereby a fired compact can be obtained. It is necessary to set the firing temperature to be lower than the crystallization initiation temperature of the amorphous metal powder.

The obtained amorphous powder magnetic core has a density of 5.6 or more and a specific magnetic permeability at 1 kHz of 60 or more, preferably 65 or more, more preferably 70 or more.

### EXAMPLE 11

An amorphous metal powder of (Fe_{0.97}Cr_{0.03})₇₆ (Si_{0.5}B_{0.2})₂₂C₂ coated with a low melting point glass powder (containing 60 to 80% by mass of P₂O₅, 10% by mass or less of Al₂O₃, 10 to 20% by mass of ZnO, 10% by mass or less of Li₂O, and 10% by mass or less of Na₂O, and having a particle size of 40 μm or less) by a powder coating process was used. Zinc stearate was used as a lubricant. The prepared Fe—Cr—Si—B—C-based amorphous metal alloy powder was adjusted to have an average particle size of 40 μm to 100 μm by using a sieve.

A Fe—Cr—Si—B—C-based amorphous metal alloy powder having a different particle size was produced in a similar manner, and the average particle size thereof was adjusted to 1 μm to 10 μm.

In 100 parts by mass of the amorphous metal alloy powder having a large particle size prepared above, 18 parts by mass of an amorphous metal alloy powder having a small particle size was blended, and secondary particles were produced by a tumbling fluidized granulation process.

To 100 parts by mass of the secondary particle powder, 0.6 part by mass of zinc stearate was added, and the resulting mixture was mixed at a temperature of 112° C. by using a ball mill to give a composite powder.

The composite powder was filled in a mold, and was press-molded at a predetermined pressure to give a pressurized powder. The pressurized powder was then fired at 480° C. for 15 minutes in an atmospheric atmosphere to burn out the resin, whereby a fired compact (diameter: 10 mm, inner diameter: 5 mm, thickness: 5 mm) was obtained.

The density of the obtained amorphous powder magnetic core was calculated from the size and weight obtained by a geometric measurement. Furthermore, the magnetic permeability was measured as a magnetic permeability at 1 kHz in accordance with JIS C2561. The results are shown in Table 1.

### EXAMPLE 12

An amorphous powder magnetic core was obtained in a similar manner to that of Example 11, except that secondary particles were produced by a tumbling fluidized granulation process by blending 25 parts by mass of the amorphous metal alloy powder having a small particle size to 100 parts by mass of the amorphous metal alloy powder having a large particle size. The density and magnetic permeability were measured in a similar manner to that of Example 11. The results are shown in Table 1.

### EXAMPLE 13

An amorphous powder magnetic core was obtained in a similar manner to that of Example 11, except that secondary particles were produced by a tumbling fluidized granulation process by blending 45 parts by mass of the amorphous metal alloy powder having a small particle size to 100 parts by mass of the amorphous metal alloy powder having a large particle size. The density and magnetic permeability were measured in a similar manner to that of Example 11. The results are shown in Table 1.

### EXAMPLE 14

An amorphous powder magnetic core was obtained in a similar manner to that of Example 11, except that secondary particles were produced by a tumbling fluidized granulation process by blending 55 parts by mass of the amorphous metal alloy powder having a small particle size to 100 parts by mass of the amorphous metal alloy powder having a large particle size. The density and magnetic permeability were measured in a similar manner to that of Example 11. The results are shown in Table 1.

### COMPARATIVE EXAMPLE 3

An amorphous powder magnetic core was obtained in a similar manner to that of Example 11, by using only an amorphous metal alloy powder whose particle size had been adjusted to 50 μm. The density and magnetic permeability were measured in a similar manner to that of Example 11. The results are shown in Table 1.

TABLE 1

| | | | | | Com- |
|---|---|---|---|---|---|
| | Exam- | Exam- | Exam- | Exam- | parative |
| | ple 11 | ple 12 | ple 13 | ple 14 | Example 3 |
| Specific magnetic | 65 | 80 | 70 | 65 | 52 |
| permeability μs, | | | | | |
| 1 KHz | | | | | |
| Density (g/cm³) | 5.67 | 5.78 | 5.76 | 5.67 | 5.40 |

### INDUSTRIAL APPLICABILITY

The magnetic core part of the present invention can be miniaturized by use of an amorphous metal powder, and thus can be utilized in electronic devices that are made smaller and lighter in the future. Furthermore, the magnetic core part (amorphous powder magnetic core) of the present invention can increase the density and magnetic permeability, and thus can be utilized for various electric and electronic devices in the future.

### EXPLANATION OF REFERENCE NUMERALS AND SYMBOLS

1 Magnetic core part
2 Copper enameled wire
3 Pressurized powder-molded magnetic substance and/or pressurized powder magnet-molded article
11 Amorphous metal powder having large average particle size
12 Amorphous metal powder having small average particle size
13 Overlapped part

1. A magnetic core part formed by thermoset molding a mixture of a magnetic powder and a thermosetting binder resin,
the magnetic powder being at least one magnetic powder selected from an amorphous metal powder alone and an amorphous metal powder coated with an insulating material,
the magnetic core part containing the magnetic powder in an amount of 90% by mass or more and 99% by mass or less with respect to the total amount of the magnetic powder and the thermosetting binder resin.

2. The magnetic core part according to claim 1, wherein the thermosetting binder resin is an epoxy resin that is cured by a latent curing agent.

3. The magnetic core part according to claim 1, wherein either one of a pressurized powder-molded magnetic substance and a pressurized powder magnet-molded article is insert-molded in the mixture.

4. A magnetic element comprising a magnetic core part and a coil wound around the magnetic core part, which is incorporated in an electronic device circuit,
the magnetic core part being the magnetic core part according to claim 1.

5. A method for producing the magnetic core part according to claim 1, comprising:
a mixing step of dry-mixing a mixture of the magnetic powder and the thermosetting binder resin at a temperature equal to or higher than the softening temperature of the binder resin and lower than the thermal curing initiation temperature of the binder resin;
a pulverizing step of pulverizing an agglomerated cake produced in the mixing step at room temperature to give a composite magnetic powder;
a compression molding step of forming the composite magnetic powder into a compression-molded article by using a mold; and
a curing step of thermally curing the compression-molded article at a temperature equal to or higher than the thermal curing initiation temperature of the binder resin.

6. The method for producing the magnetic core part according to claim 5, wherein the compression molding step is a step of inserting either one of a pressurized powder-molded magnetic substance and a pressurized powder magnet-molded article in the composite magnetic powder, followed by compression molding.

7. The method for producing the magnetic core part according to claim 5, wherein the amorphous metal powder is secondary particles formed of at least two kinds of amorphous metal powders having different average particle sizes and different particle size distributions, the secondary particles contain an amorphous metal powder having a large average particle size as central particles, and an amorphous metal powder having a smaller average particle size than that of the central particles is adhered to surfaces of the central particles.

8. The method for producing the magnetic core part according to claim 7, wherein the particle size distribution of the amorphous metal powder that serves as the central particles and the particle size distribution of the amorphous metal powder adhered to the surfaces of the central particles have, in a particle size distribution diagram in which abundance rates are plotted on the vertical axis and particle sizes are plotted on the horizontal axis, at least 10% or less of a part in which the particle size distributions overlap.

9. A magnetic core part formed by compression-molding an amorphous metal powder whose surface is coated with an insulating layer,
the amorphous metal powder being secondary particles formed of at least two kinds of amorphous metal powders having different average particle sizes and different particle size distributions, the secondary particles containing an amorphous metal powder having a large average particle size as central particles, an amorphous metal powder having a smaller average particle size than that of the central particles being adhered to surfaces of the central particles.

10. The magnetic core part according to claim 9, wherein the magnetic core part has a density of 5.6 or more and a specific magnetic permeability of 60 or more.

11. The magnetic core part according to claim 1, wherein the particle size distribution of the amorphous metal powder that serves as the central particles and the particle size distribution of the amorphous metal powder adhered to the surfaces of the central particles have, in a particle size distribution diagram in which abundance rates are plotted on the vertical axis and particle sizes are plotted on the horizontal axis, at least 10% or less of a part in which the particle size distributions overlap.

12. The magnetic core part according to claim 1, wherein the insulating layer is an inorganic insulating layer formed of at least an inorganic insulating material.

13. A method for producing the magnetic core part according to claim 10, comprising:
a step of producing an amorphous metal powder having an inorganic insulating layer on each of surfaces of the at least two kinds of amorphous metal powders having different average particle sizes and different particle size distributions,
a step of forming secondary particles by mixing the amorphous metal powder that has a large average particle size and that serves as central particles with the amorphous metal powder that has a smaller average particle size than that of the central particles, followed by granulation, and
a compression molding step of compression-molding the secondary particles.
